(19) United States
(12) Patent Application Publication
(10) Pub. No.: US 2014/0223809 A1
(43) Pub. Date: Aug. 14, 2014

(54) SORGHUM-CONTAINING PELLETS

(71) Applicants: Mario Carrillo, Lubbock, TX (US); Kenneth G. Davenport, Dallas, TX (US); Bob Kodrzycki, Summerville, SC (US); Scott A. Staggenborg, Manhattan, KS (US); Larry Lambright, Lubbock, TX (US)

(72) Inventors: Mario Carrillo, Lubbock, TX (US); Kenneth G. Davenport, Dallas, TX (US); Bob Kodrzycki, Summerville, SC (US); Scott A. Staggenborg, Manhattan, KS (US); Larry Lambright, Lubbock, TX (US)

(73) Assignee: CHROMATIN, INC., Chicago, IL (US)

(21) Appl. No.: 14/130,827

(22) PCT Filed: Sep. 6, 2012
(86) PCT No.: PCT/US12/53972

§ 371 Date: Mar. 6, 2014

Related U.S. Application Data
(60) Provisional application No. 61/535,462, filed on Sep. 16, 2011.
(60) Provisional application No. 61/531,608, filed on Sep. 6, 2011.

(51) Int. Cl. C10L 5/44; B29C 47/00

(52) U.S. Cl. CPC C10L 5/44; B29C 47/0011
USPC 44/577

(57) ABSTRACT

The invention is directed to compositions and methods of making pellets comprising a sorghum material, more preferably a sweet sorghum material having an average Brix value of 10 or higher. In embodiments, the pellets are highly combustible and comprise woody materials in addition to the sorghum materials.

### CROSS REFERENCE TO RELATED APPLICATION

This application claims priority to Carrillo, M. et al., U.S. Provisional Application No. 61/531,608, “SORGHUM-CONTAINING PELLETS,” filed Sep. 6, 2011; and to Carrillo, M. et al., U.S. Provisional Application No. 61/535,462, “SORGHUM-CONTAINING PELLETS,” filed Sep. 16, 2011, both of which are incorporated by reference herein in their entireties.

### FIELD OF THE INVENTION

The present invention is directed to pelletization of biomass, resulting in biomass that is easily transported and fed into bioprocesses, such as thermoconversion processes.

### GOVERNMENT SUPPORT

Not applicable.

### COMPACT DISC FOR SEQUENCE LISTINGS AND TABLES

Not applicable.

### BACKGROUND OF THE INVENTION

This invention relates to a process for preparing pellets comprising sorghum materials, specifically, pellets comprising sweet sorghum material (stem juice having a Brix value of at least 10), and more particularly, to the preparation of fuel materials from sorghum and woody materials, such as wood.

### Introduction

A challenge in converting non-conventional feedstocks to energy production via renewable technologies is the transport and storage of renewable materials, especially in the case of biomass. Unlike coal, which is mined from discrete locations, and oil, which can be transported in pipelines, biomass is grown over large areas, and once harvested, needs to be transported ultimately to its final destination, whether to a power plant that will burn the biomass as fuel, or to a processing plant that will make a drop-in fuel or chemical from components of the biomass. Examples of biomass sources include, field crops, such as corn stover, bamboo, sugarcane, and sorghum; developing crops, such as warm and cool season perennial grasses, miscanthus, guayule, jatropha, and switchgrass; forestry products, such as wood, and agricultural waste products, such as peanut shells, pecan shells, coconut shells and husks, and cotton plant stalks. To facilitate transport, the materials are desirably “condensed,” such as in a pelletization process. Often, the cost of pelletizing is justified because transportation costs are reduced as a result of excess moisture having been removed and material densification.

Biomass pellets are predominantly made from woody materials, while agro-pellets refer to non-woody materials.

Wood and wood by-products are prime examples of renewable energy materials presently in use. Wood can be used in various forms including chips, sawdust, shavings, and briquettes. Wood and fiber-based fuel materials have been shown to be processed into the form of fuel “logs,” as disclosed by Levelton (Levelton, 1966).

Pelletized wood, is not without challenges as a fuel source: such pellets have slow burning rates and exhibit incomplete burnout, resulting in formation of carbonaceous residues and low combustion efficiency. In addition, pelletized wood can be harder to ignite than coal and can be more fragile than coal, requiring special handling to avoid crumbling and to prevent weathering. To overcome the crumbling and weathering problems, inorganic binders such as cement and silicate of soda; and organic binders such as tar, pitch, rosin, glues, molasses (viscous by-product of the processing of sugarcane, grapes or sugar beets into sugar) and fibers have been included in the pellets. An ideal binder that is inexpensive and does not reduce the heating value of the wood has been difficult to identify.

Other biomass pellet methods, such as blending high-energy grasses with other agricultural products, wherein the different components are chosen based on variables such as moisture content and pre-determined energy content (Flick et al., 2011); however, Flick et al. do not disclose binders to facilitate pelletization. Myers and Hood disclose pellets and briquettes consisting at least in part of biomass, and in some embodiments, a binder, which they exemplified as wax or algae (Myers and Hood, 2010). Biomass pellet methods are less concerned with pellet composition, but instead concentrate on the physical process of pelletization. For example, one method of pelletization concerns regulating and processing the biomass before pelletization wherein the biomass is fed to a pelletizing press with a metering device; and separating the biomass with a breaker device directly before feeding the biomass to the pelletizing press (von Haas, 2010). Likewise, Zeeck discloses methods for pelletizing non-food biomass, such as methods utilizing non-food agricultural plant material comprising: harvesting agricultural plant material having no substantial food value; bailing the harvested material; transporting the baled material to a storage site; shredding the baled material; grinding the shredded material; pelletizing the ground material into pellets; transporting the pellets to a facility for use (Zeeck, 2010).

It has been attempted to use the self-binding characteristics of various species of wood due to lignin present to avoid crumbling. Self-binding is possible using some species of wood, but not all species. In these methods, wood is heated above its minimum plastic temperature of 325° F. (Gunnerman, 1977). However, such high temperatures can severely limit the operating life of the pelletizing equipment and drive high BTU volatile components from the wood.

Agricultural materials have been examined as sources of alternative energy, such as warm and cool season perennial grasses, sweet sorghum, corn stover, bamboo, miscanthus, switchgrass, and sugarcane.

Sorghum (Sorghum bicolor) is classified in three general forms: grain, forage and sweet. Sorghum is more resistant to colder temperatures than sugarcane. It also requires less humid climates than sugar cane. Sorghum is a tropical grass that can be grouped into three basic types: (i) grain, (ii) forage, and (iii) sweet sorghum (Monk et al., 1984). Sorghum is indigenous to Africa (Monk et al., 1984). Over 22,000 varieties of sorghum exist throughout the world. (Development of sweet sorghum as an energy crop, 1980)

Sorghum has many advantageous biological characteristics, including a high photosynthetic rate and high drought tolerance. Sorghum can grow under intense light and heat. In addition, sorghum plants have a waxy surface (epicuticular wax) which reduces internal moisture loss and facilitates drought resistance.

Sugars derived from sweet sorghum materials (typically classified as “sweet” when stem juice is measured to have an average Brix value of 16 or greater) can be used in the production of ethanol and other alternative fuels, as well as a starting material for chemicals. Sorghum can also be used as a fuel source as a substitute for coal or wood—by burning it through combustion. For example, forage sorghum, non-grain portions of grain sorghum plants, and sweet sorghum bagasse (created through the removal of sugar-containing fluids from sorghum) contain considerable quantities of ligno-cellulosic residue.

Pelletizing sorghum plant material has not been well explored. Gunnerman discloses methods for preparing and using a combustible fuel product using sweet sorghum (Gunnerman and Farone, 1986). In the disclosed methods, a sorghum variety high in sugar, high in biomass, and low in nitrogen is first processed to remove a majority of sugars. The remaining ligno-cellulosic residue, the bagasse, is converted intowhat Gunnerman calls “combustible pellets” (more appropriately termed “compressed bagasse bundles”) or alternatively stored for future bundling. Storage is accomplished by first piling the bagasse on a hard surface. The bagasse is then compressed to form a compacted mass. Compression frees trapped air in the pile, hindering oxidative degradation by bacteria and other microorganisms. However, these methods are directed at storing the bagasse and making loose, large compressed bagasse bundles. For example, these bundles are prepared from piles of bagasse that are 10 to 20 feet high, and pressure is applied at 35 psi to 60 psi. In pellets more suitable for transport and use as fuel, Johnston discloses high heating value, fuel pellets comprising from about 50 to about 99% by weight natural cellulosic material and from about 1 to about 50% by weight synthetic polymeric thermoplastic material (Johnston, 1980). The synthetic thermoplastic material is uniformly distributed throughout the fuel pellet. The thermoplastic material is solid at room temperature and has an injection molding temperature of at least 200° F. Such a pellet can be prepared in a pelletizer where the temperature of the pellet as it emerges from the die is from about 150 to about 250° F. However, such methods and pellets have the disadvantage of requiring a thermoplastic material, such as polystyrene, polyethylene, polypropylene, acrylonitrile-butadienestyrene, acetal copolymer, acetal homopolymer, acrylic, polybutylene, and combinations thereof, which are often derived from petroleum, and can be toxic to handle at different stages of processing.

Therefore, there is a need for a fuel pellet which resists crumbling, is easily ignitable, burns fast and virtually completely, and ideally has a heating value approaching that of coal.

### SUMMARY OF THE INVENTION

In a first aspect, the invention provides for pellets comprising a sweet sorghum material, wherein the sweet sorghum material functions to bind the components of the pellet. In some embodiments, the sweet sorghum material comprises at least 1-10% of the pellet, e.g. at least about including at least about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, and about 75%. The sweet sorghum material can be sweet forage or sweet sorghum, generally having an average Brix value of at least about 10, including average Brix values of 10, 11, 12, 13, 14, 15, 16, 16, 18, 19, 20 or more. The pellet can further comprise a biomass or high-energy crop, such as warm and cool season perennial grasses, sorghum, corn stover, bamboo, miscanthus, switchgrass, and sugarcane; agricultural waste products, guayule and woody material. In some embodiments, the pellet is highly combustible.

In a second aspect, the invention provides for pellets suitable for combustion, wherein the pellet comprises a sorghum material and a woody material. For example, the sorghum material may be a sweet sorghum material (generally having an average Brix value of at least 10), which may include juice, bagasse, stalks, leaves, stems, grain, or a combination thereof. The woody material may be supplied as wood chips, splinters, sawdust, or fine particles before being pelletized, and may be derived from, for example, maple, oak, cherry, mahogany, poplar, aspen, birch, beech, spruce, fir, kenaf, pine, walnut, cedar, redwood, chestnut, acacia, bombax, alder, eucalyptus, catalpa, mulberry, persimmon, ash, honey locust, sweetgum, privet, sycamore, magnolia, sourwood, cottonwood, mesquite, buckthorn, locust, willow, elderberry, teak, linden, bubinga, basswood, forest trees, fruit trees, ornamental trees, nut-bearing trees, and shrubs. Harvest moistures can exceed 50-65% for the sorghum material and 15% for the woody material.

In some embodiments, the woody material comprises less than 5% of the pellet, or as much as over 99% of the pellet, including 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%. 90%, 95%, 96%, 97%, 98% and 99%. Likewise, in other embodiments, the sorghum material may comprise less than 1% of the pellet, or over 99% of the pellet, including 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%. 90%, 95%, 96%, 97%, 98%, and 99%.

The woody material and the sorghum material may be “pre-processed” before pelletizing, often to facilitate pelletization, or to conform to the specifications of an application, such as combustion in a power plant. Such processing in woody materials can include drying to a target moisture content, chopping, shredding, sawing, grinding, removing seeds, nuts or fruit, and cleaning (such as removing insects, debris, insecticides, and herbicides, such as by washing). Such processing in sorghum material can include drying to a target moisture content, chopping, shredding, sawing, grinding, extracting juice, removing grains, and cleaning. However, in some embodiments, juice is not extracted to maintain a high sugar content, although the material may still be, for example, dried to a target moisture.

In some embodiments, such pellets can also contain additional materials, such as a thermoplastic material or additional biomass materials, including agricultural waste products. In additional embodiments, thermoplastic material can be present as less than 1% of the pellet composition, or greater than 50%. Such materials are added to the pre-pellet mix before applying pressure and heat.

In some embodiments, some of the sugars are removed from the sorghum material (sorghum bagasse) or the other co-pelletized materials (e.g., sugarcane, creating sugarcane bagasse).

In a second aspect, the invention provides methods of pelletizing a first material, such as a woody material, with a second material, such as a sorghum material. The sorghum material can be a sweet sorghum material having a Brix value of at least 10. The harvest moisture of the sorghum material can be greater than about 50%. The methods can further comprise processing the first and second materials to a first particle reduction step, and alternatively, these materials once reduced to a target length, such as about 1″ or less, they may be subjected to a second particle reduction step to reduce the length to about ⅜″ or less. Alternatively, the first particle reduction step is the only particle reduction step, and reduces the materials to about ⅜″ to about 1″. After any particle reduction step, the first and second materials may be mixed, such as can be accomplished using a drum mixer, a ribbon mixer, or by co-feeding the materials into a pelletizer. The mixed first and second materials are pelletized in a pelletizer, such as can be done with a ring die pellet mill or screw pellet extruder. The resulting pellets can have a diameter of about 2/8″ (¼″), ⅜″, 4/8″ (½″), ⅝″, 6/8″ (¾″), ⅞″ to about 1″ (and increments in between, including, for example, 3/16″ and 11/64″) or more. Pellets can be cast to have a length of about ½″, ¾″, 1″, 1½″, 1¾″ to 5 inches, including increments in between, including, for example, 1⅜″, 2″, 2¼″, 2½″, 2¾″, 3″, 3¼″, 3½″, 3¾″, 4, 4¼″, 4½″, 4¾″ and about 5″. Before pelletizing, a third material (or more), such as a biomass material or a binder, may be added.

The invention provides for pellets comprising a sweet sorghum material, wherein the sweet sorghum material functions to bind components of the pellet. The pellets of the invention include those in which the sweet sorghum material comprises at least about 1% of the pellet, and those in which the sweet sorghum material comprises at least about 20% to about 30% of the pellet, those in which the sweet sorghum material comprises at least about 5% to about 10%, at least about 10% to about 20%, at least about 20% to about 40%, at least about 30% to about 50%, and at least about 50% to about 75%. In any of the pellets of the invention, the sorghum material is sweet sorghum or sweet forage sorghum.

In addition, in any of the pellets comprising a sweet sorghum material, wherein the sweet sorghum material functions to bind components of the pellet, the pellets may further comprise a biomass material. In these pellets, the biomass material may be from an energy crop, such as an energy crop, which is selected from the group consisting of warm and cool season perennial grasses, sugarcane, sorghum, corn stover, miscanthus, switchgrass, bamboo, guayule and woody material, or an agricultural waste product.

In any of the pellets comprising a sweet sorghum material, wherein the sweet sorghum material functions to bind components of the pellet, the pellet may be highly combustible.

The invention also provides for a pellet comprising a sorghum material and a woody material. These pellets include those in which the sorghum material is sweet sorghum material having a Brix value of at least 10, including Brix values of 11, 12, 13, 14, 15, 16, 16, 18, 19, 20 or more. The sweet sorghum material can be selected from the group consisting of bagasse, stalks, leaves, stems, grain, or a combination thereof.

In any of the pellets, the woody material can be in the form of wood chips, splinters, sawdust, or fine particles before being pelletized. Woody material can be selected from the group consisting of maple, oak, cherry, mahogany, poplar, aspen, birch, beech, spruce, fir, kenaf, pine, walnut, cedar, redwood, chestnut, acacia, bombax, alder, eucalyptus, catalpa, mulberry, persimmon, ash, honey locust, sweetgum, privet, sycamore, magnolia, sourwood, cottonwood, mesquite, buckthorn, locust, willow, elderberry, teak, linden, bubinga, basswood, forest trees, fruit trees, ornamental trees, nut-bearing trees, and shrubs.

In any of the pellets, the pellets can comprise at least about 1%-65%, 5%, 10%, 50%, or more, sweet sorghum material, such as 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%. 90%, 95%, 96%, 97%, 98%, and 99% of sweet sorghum material.

In any of the pellets, the pellets can comprise at least about 99%-35%, 95%, 90%, 50%, 35% or less of woody material, including 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%. 90%, 95%, 96%, 97%, 98%, and 99% of woody material.

In any of the pellets, the woody material can be processed before pelletizing. Processing can include at least one or more selected from the group consisting of: drying to a target moisture content, chopping, shredding, sawing, grinding, removing seeds, nuts or fruit, and cleaning. Likewise, the sorghum material can be processed before pelletizing. Processing can include at least one or more selected from the group consisting of: drying to a target moisture content, chopping, shredding, sawing, grinding, extracting juice, removing grains, and cleaning. In some embodiments, processing of the sorghum material does not include extracting juice. In other embodiments, some, most or all of the sugar is not removed from the sorghum material.

In any of the pellets, a binder can be included.

In any of the pellets, the pellets can comprises less than 1% thermoplastic material, or greater than 50% thermoplastic material, including 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50% thermoplastic material

In any of the pellets, the woody material can come from more than one kind of woody plant.

In other embodiments of the invention, the invention comprises methods of making pellets comprising selecting a first material to be pelletized, and co-pelletizing with a second material comprising sorghum.

In making any such pellets, the second material can be a sorghum having a Brix value of at least 10, including Brix values of 11, 12, 13, 14, 15, 16, 16, 18, 19, 20 or more.

In making any such pellets, the harvest moisture of the sorghum material is greater than 50%-65%, including 51%, 52%, 53%, 54%, 55%, 60% and 65%.

In making such pellets, the first material can be a woody material, such as wood.

In making any of the pellets, the sorghum material and the first material are subjected to a first particle reduction size step to have a mean particle size of about 1″ or less in length. In some embodiments, a second particle reduction size step is used, wherein the sweet sorghum material and the biomass material are subjected to a second particle reduction size step to have a mean particle size of about ⅜″ or less in length. However, in other methods of making any of the pellets, the sorghum material and the first material are subjected to a single particle reduction size step to have a mean particle size of about ⅜″ to 1″ in length. Regardless of the number of particle reduction steps, the sweet sorghum material and the first material are mixed after the first or second particle reduction step, or after a single particle reduction size step.

In making any of the pellets, mixing the sorghum material and first material can be accomplished by placing the first and second materials in a drum mixer, a ribbon mixer, or by co-feeding in a stream into a pelletizing device after the first or second particle reduction step, or after a single particle reduction size step.

In making any of the pellets, the mixture of the first and second materials is formed into pellets in a ring-die pellet mill or in a screw pellet extruder, creating pellets having a diameter of about ¼″ to 1″, including diameters of 2/8″ (¼″), ⅜″, 4/8″ (½″), ⅝″, 6/8″ (¾″), ⅞″ to about 1″ (and increments in between, including, for example, 3/16″ and 11/64″) or more. Pellets can be cast to have a length of about ½″, ¾″, 1″, 1½″, 1¾″ to 5 inches, including increments in between, including, for example, 1⅜″, 2″, 2¼″, 2½″, 2¾″, 3″, 3¼″, 3½″, 3¾″, 4, 4¼″, 4½″, 4¾″ and about 5″.

In making any of the pellets, of course, the resulting pellets may comprise at least a third material. Furthermore, the resulting pellets may further comprise a binder.

### BRIEF DESCRIPTION OF SEVERAL VIEWS OF THE DRAWINGS

Not applicable

### DETAILED DESCRIPTION

The invention solves the problems of providing an economical method of forming pellets comprising plant materials, including woody materials and other plant biomass, with sorghum material to produce a pellet that is easily transportable, durable, and in preferred embodiments, suitable for biopower applications, such as combustion in co-firing applications. Such pellets are easy to transport, akin to transporting coal, easily stored because of their compact nature, requiring much less space than, for example, bales or logs of biomass, and are immediately ready for a power plant's technology, in the case of pellets made with combustible biomass.

The invention solves these problems by providing compositions that comprise a sorghum material. Typically, such sorghum material has a high sugar content (stem juice having an average Brix value of 10 or higher), and is exemplified by sweet sorghum (classically classified as having a Brix value of 16 or higher) and sweet forage sorghums.

An exemplification of the invention is the co-pelletization of woody material with sorghum material. The invention thus enables production of “agro-biomass pellets” that have the advantages of using highly renewable biomass resources, such as warm and cool season perennial grasses, sorghum, switchgrass, miscanthus, bamboo, guayule, sugarcane, and corn stover, and off-setting those materials' disadvantages (ash, silica content) by combining them with wood. In some applications, the woody material is predominant, and the sorghum material acts as a binder—but a binder that itself is primed with energy molecules, thus the binder in this instance does not dilute the power density of the produced pellets. Because sorghum harbors energy molecules (lignin, hemicellulose) that are amenable to power plant technologies, other embodiments of the invention are predominately sorghum or other biomass material, with woody material, if present at all, acting as an “extender” or as a means to off-set an undesirable characteristic of the other components (e.g., ash content). In woody-sorghum co-pellet embodiments, the woody material can come from multiple sources—from a mix of trees, for example; and likewise, the sorghum material can come from the different kinds of sorghum—grain, sweet, and forage. In most embodiments, however, the sorghum material is sweet sorghum or sweet forage sorghum, as it is believed that the sugar molecules naturally present provide the binding capacity that enable good pelleting. The advantage of such co-pelletizing allows for one of skill in the art to develop blends that are applicable to particular technologies. For example, pellets can be blended with different kinds of sorghum, woods, and other biomass to enable minimizing ash content, which is an undesirable by-product of biomass combustion in power plant electricity generation.

### Definitions

Unless defined otherwise, all technical and scientific terms used herein have the same meaning as commonly understood by one of ordinary skill in the art to which this invention is related. The following terms are defined for purposes of the invention as described herein.

“About” or “approximately” when referring to any numerical value are intended to mean a value of plus or minus 10% of the stated value.

“Pellet” is understood as generally understood by one of skill in the art. Pellets are most often cylindrical, and can have a range of diameters and lengths. Typically, pellets are ¼ to 11/64 inches or larger, including diameters of 2/8″ (¼″), ⅜″, 4/8″ (½″), ⅝″, 6/8″ (¾″), ⅞″ to about 1″ (and incremenets in between, including, for example, 3/16″ and 11/64″) . Pellets can be cast as having different lengths, typically from ½″, ¾″, 1″, 1½″, 1¾″ to 5 inches or longer, including increments in between, including, for example, 1⅜″, 2″, 2¼″, 2½″, 2¾″, 3″, 3¼″, 3½″, 3¾″, 4, 4¼″, 4½″, 4¾″ and about 5″. Often, pellets will be produced or break that are shorter than the die used to cast them; for the purposes of the invention, length uniformity is unnecessary. While most practical to form cylindrical pellets, pellets can be in any suitable configuration, such as a cube.

“Plant part” includes pollen, silk, endosperm, ovule, seed, embryo, pods, roots, cuttings, tubers, stems, stalks, fiber (lint), square, boll, fruit, berries, nuts, flowers, leaves, bark, wood, whole plant, plant cell, plant organ, epidermis, vascular tissue, protoplast, cell culture, crown, callus culture, petiole, petal, sepal, stamen, stigma, style, bud, meristem, cambium, cortex, pith, sheath, or any group of plant cells organized into a structural and functional unit. In one preferred embodiment, the exogenous nucleic acid is expressed in a specific location or tissue of a plant, for example, epidermis, vascular tissue, meristem, cambium, cortex, pith, leaf, sheath, flower, root or seed.

“Sorghum” means sorghum, sorghum-sudan grass, sudangrass, and sweet sorghums of the species of Sorghum, including Sorghum bicolor and Sorghum sudanense, and hybrids thereof. Sorghum has three main types: sweet, forage and grain sorghum; each can exist as a cultivar or as a hybrid. Forage sorghum can also exist as “sweet forage sorghum” when it contains a high sugar content (Examples of a sweet forage sorghum is Sucrosorgo 405 available from Sorghum Partners, LLC (New Deal, Tex. (USA)). A “sweet sorghum material” is any sorghum that has stem juice having an average Brix value of at least about 10, including average Brix values of 11, 12, 13, 14, 15, 16, 16, 18, 19, 20 or more.

“Wood” or “woody material” means a composite of cellulose embedded in a matrix of lignin which resists compression. Typically, a plant produces wood as secondary xylem in the stems of trees and bushes, as well as other woody plants. Examples of woody plants include maple, oak, cherry, mahogany, poplar, aspen, birch, beech, spruce, fir, kenaf, pine, walnut, cedar, redwood, chestnut, acacia, bombax, alder, eucalyptus, catalpa, mulberry, persimmon, ash, honey locust, sweetgum, privet, sycamore, magnolia, sourwood, cottonwood, mesquite, buckthorn, locust, willow, elderberry, teak, linden, bubinga, basswood or elm. Other examples include other types of trees such as forest (broad-leaved trees or evergreens, such as conifers), fruit, ornamental, or nut-bearing trees, as well as shrubs and other nursery stock.

### Composition and Pre-Processing

In one embodiment, the invention provides pellets that use as at least one sweet sorghum material. Typically, such material is sweet sorghum or a high-sugar forage, the so-called “sweet forage” sorghum.

In one embodiment of the invention the pellet comprises a sorghum material and a woody material. For example, the sorghum material may be a sweet sorghum material, which may include any part of a sweet sorghum material plant, including juice, bagasse, stalks, leaves, stems, grain, or a combination thereof. The woody material may be supplied as wood chips, splinters, sawdust, or fine particles before being pelletized, and may be derived from any kind of tree or woody plant, for example, maple, oak, cherry, mahogany, poplar, aspen, birch, beech, spruce, fir, kenaf, pine, walnut, cedar, redwood, chestnut, acacia, bombax, alder, eucalyptus, catalpa, mulberry, persimmon, ash, honey locust, sweetgum, privet, sycamore, magnolia, sourwood, cottonwood, mesquite, buckthorn, locust, willow, elderberry, teak, linden, bubinga, basswood, forest trees, fruit trees, ornamental trees, nut-bearing trees, and shrubs.

The composition of the pellet, including the balance between the woody material and the sorghum material, can be adjusted to suit particular applications. While the invention here typifies pellets that are suitable for combustion in power plant applications, pellet composition can be adjusted for any application that uses wood and other plant materials. For example, such pellets can be used as a method to transport biomass to facilities that extract starting molecules for proprietary technologies to make high-value chemicals. In such applications, the component supplying the starting molecule is enriched in the pellet—typically, the sorghum or other non-woody plant material.

Pellets can also comprise other components, which in themselves may be the high value part of the pellet. For example, the woody and sorghum materials act as a carrier, such as pharmaceutical bases act as a carrier for the active ingredient. In yet other applications, other binders may be desirable to achieve certain physical characteristics of the pellet. Such binders include cement, thermoplastic binders (as disclosed by Johnston (Johnston, 1980), including polystyrene, polyethylene, polypropylene, acrylonitrile-butadienestyrene, acetal copolymer, acetal homopolymer, acrylic, polybutylene, and combinations thereof,) and soda silicates, and organic binders such as tar, pitch, rosin, glues, as well as paraffin slack wax, carnuba wax, and lignosulfonates, such as ammonium lignosulfonate, sodium lignosulfonate, calcium lignosulfonate, and magnesium lignosulfonate. In yet other embodiments, oxidizing agents, such as sodium perchlorate and ammonium nitrate, can be included in the pellets to facilitate combustion in the case of pellets being used in combustion-type power plants. In yet other embodiments, certain materials can be added to the pellets as a pelletizing or processing aid. Materials in this category include oil seeds and their products, which by their fatty acid content reduce wear on the dies of the pelletizing equipment. Exemplary of such materials which can be included are coconut husks, soy beans, peanuts, sunflower seeds, corn cake, and pressing residuals.

In some embodiments, the woody material comprises less than 5% (or even less than 1%) of the pellet, and as much as over 99% of the pellet, including 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%. 90%, 95%, 96%, 97%, 98% and 99%. Likewise, in other embodiments, the sorghum material may comprise less than 1% of the pellet, and over 99% of the pellet, including 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%. 90%, 95%, 96%, 97%, and 98%. In most applications, however, the sweet sorghum material is ideally between 10%-30%. Examples of various compositions are shown in Table 1.

TABLE 1
Examples of Pellet Composition (each component expressed as %)+

| Woody material* | Sweet sorghum material** | Other*** |
|---|---|---|
| 99 | 1 | 0 |
| 90 | 10 | 0 |
| 75 | 25 | 0 |
| 50 | 50 | 0 |
| 25 | 75 | 0 |
| 10 | 90 | 0 |
| 1 | 99 | 0 |
| 90 | 1 | 9 |
| 80 | 10 | 10 |
| 65 | 25 | 10 |
| 40 | 50 | 10 |
| 25 | 75 | 25 |
| 10 | 90 | 50 |
| 1 | 99 | 75 |
| 5 | 5 | 90 |
| 1 | 1 | 98 |

+while percentage compositions are exemplified in this table and as whole numbers, fractional percentages (e.g., 5.5%) are also contemplated, as well as materials that are present at less than 1%, including such materials as additional binders.
*numbers refer to total contribution from woody material, whether from a single source (for example, one kind of tree), or multiple sources, as well as different forms (for example, sawdust, chips, etc.).
**numbers refer to total contribution from sorghum material, although preferably the sorghum material is sweet sorghum material. Sorghum material may be supplied in different physical forms, including processed (chopped, ground, etc.) or different plant parts.
***this category includes materials that can be used as additional binders, as well as materials of interest, such as other biomass materials, such as miscanthus or corn stover.

The woody material and the sorghum material may be “pre-processed” before pelletizing, often to facilitate pelletizing, or to conform to the specifications of an application, such as combustion in a power plant. Such processing in woody materials can include drying to a target moisture content, chopping, shredding, sawing, grinding, removing seeds, nuts or fruit, and cleaning (such as removing insects, debris, insecticides, and herbicides). Such processing in sorghum material can include drying to a target moisture content, chopping, shredding, sawing, grinding, extracting juice, removing grains, and cleaning. However, in some embodiments, sorghum juice is not extracted to maintain a high sugar content, although the material may still be, for example, dried to a target moisture. In other embodiments, the sweet sorghum material juice is removed, creating bagasse, which is suitable for the purposes of the invention.

In some embodiments, such pellets can also contain additional materials, such as a thermoplastic material. In additional embodiments, thermoplastic material can be present at less than 1% of the pellet composition, or greater than 50%. Such materials are added to the pre-pellet mix before applying pressure and heat.

In some embodiments, some of the sugars are removed from the sorghum material before pelletization.

### Pelletization

Pelletization can be accomplished by any method known in the art and that is suitable for the materials being pelletized. One of skill in the art can readily assemble and adjust the equipment and processes necessary to produce high quality pellets of the present invention.

Pellets are generally described as the agglomeration of small particles into large particles by the means of a mechanical process and in some instances, a thermal process as well. Pelleting is accomplished by applying pressure and heat during an extrusion process. The purpose of pelleting is to increased density, combine disparate materials into one final component and to improve flowability of the product for bulk handling. Pellet bulk densities often range from 30 to 45 lbs ft⁻³. Generally, pellets are produced by forcing milled materials through a die and then allowing the resulting pellet to cool. Heat resulting from the friction of forcing the biomass through the die “melts” the lignin (and somewhat any hemi-cellulose), binding the pellet during the cooling process. In the present invention, the sugars from the sweet sorghum material act as a binder. Key quality processes in biomass/agro pellets include adequate size reduction of the input biomass to between 2 and 10 mm (discussed further below), controlling the input moisture to a target moisture of preferably 10-15%, and controlling the cooling of the pellets to ensure durability.

Pelleting procedures and pellet composition can be adjusted to meet a variety of criteria. In manufacturing, the most important standards for pellet quality include chemical composition, BTU value, ash content, size and durability. In North America, two organizations put forth pellet manufacturing standards, the Pellet Fuels Institute and the U.S. Industrial Pellet Association. Parallel organizations exist in Europe and other countries. Furthermore, pellets can be certified from environmental standpoints, as determine by, for example, the Sustainable Forestry Initiative, the American Tree Farm System, and the Forest Stewardship Council (all US). Similar certifications are being developed in other countries.

For example, a raw material of random particle size such as, for example, sawdust or other wood product waste, or in the case of sorghum material or other biomass/energy crop, as whole plant or stalks, but preferably as chopped segments, more preferably chopped segments 6″ or less, and of non-uniform water content is conveyed through a conventional conveyor to a hammer mill where the particle size is adjusted to a substantially uniform maximum dimension which is about 85% or less of the minimum thickness of the pellet to be produced. Rocks, metal and other foreign material are separated from the wood or plant material, often on a conveyor, before it reaches a mill, such as a hammer mill. Any other type of conveyor which will tend to separate foreign material from the material to be pelletized can be used. In cases where the material is not already at a target moisture, such as may be attained by allowing the material to dry in the field-before or after harvest, the product from the hammer mill is conveyed to a rotary drum type dryer where the moisture content of the substantially uniformly dimensioned particles is adjusted to a target moisture content, often from about 5% to about 30% by weight free moisture, and more preferably 10-15%. The choice of moisture content is dictated in part by the types of particles being pelletized, and this variable is readily determined by one of skill in the art. Noted, however, is that when the free moisture content of cellulosic material is reduced to less than about 5% by weight, the pellets upon discharge from the pelletizer may burst and demonstrate a “Christmas tree” effect. These pellets are unsatisfactory because they tend to form fines in storage and handling. This problem can be overcome by introducing steam, as necessary, at the pelletizer. However, it is undesirable to remove moisture from the cellulosic feed in a dryer, thereby expending energy for this purpose, only to put the moisture back into the feed at the pelletizer. Therefore, it is preferred that the free moisture content of the cellulosic material be reduced to no less than about 10% by weight. To aid in drying the feed material, dry slaked lime (calcium carbonate), can be combined with the dryer feed. The calcium carbonate combines with water of the feed material and then releases moisture more easily in the dryer, thereby aiding more rapid drying of the feed material. Use of calcium carbonate in an amount of from about 2 to about 10% by weight of the feed, and preferably in an amount of about 5% by weight, significantly aids in the drying process. The preferred grade of calcium carbonate is a fine grade having a particle size of less than 100 mesh. When this drying technique is used, the product fuel pellets contain at least 1% by weight calcium. However, some applications may be disadvantageously served by the presence of minerals, such as calcium in the pellets. In some applications, the feed may need to be reduced in size in two rounds before pelletization, a first round that is more heterogenous in size, and a second round that results in a more homogenous (and often smaller) particle size.

Materials containing high amounts of water can be dried before being prepared as a feed for pelletization. Materials can be pressed or dried, for example, using techniques well-known in the art.

The feed is then mixed, such as in a mixing chamber, before pelletization, to aid in the even distribution of the materials.

After the particles have been adjusted to the target moisture content, they are conveyed, preferably in a conveyor, to a pelleting machine. Any suitable pelleting machine may be used such as, for example, the one produced by California Pellet Mill Company (San Francisco, Calif.; USA). In this apparatus, the material is fed into a hopper and pressed in dies having the desired configuration and shape. The pellet mill must be capable of producing a pressure in the die during compression which will cause the temperature of the fibrous material to increase to a point within the range of from about 325° F. to about 350° F. However, some applications, especially when pellets are co-pelleted with thermoplastic materials, lower temperatures are necessary to prevent material changes in the components. For example, thermoplastic-containing pellets are preferably pelletized at 150° F. to 250° F.

The California Pellet Mill, for example, exerts an applied pressure of about 40,000 pounds load at the impact point of the rollers. With some mills the pressure may be as low as 8,000 pounds load and pressures above 40,000 pounds may be used. Pressures within this range will produce the desired temperature during pelletizing. Wax-like materials in the ligno-cellulosic material and sugars will exude therefrom and form a surface skin on the pellet which protects the pellet from shattering and rapid change in moisture content when the fuel is used. Other examples of a suitable pelletizing machines are made by Andritz (Andritz AG; Graz, Austria), Buhler (Buhler, Inc., Plymouth, Minn., USA), Diffenbacher (Diffenbacher USA, Inc., Alpharetta, Ga., USA), and Amandus Kahl (Reinbek, Germany).

The pellets emerging from the pellet mill are cooled, and if necessary, their moisture adjusted. For example, the emerged pellets may be spread over a rotating endless belt conveyor where fans blow air over them to adjust the temperature and moisture content to approximately ambient. Additionally, they may be cooled in a pellet cooling manifold or on a cooling chain. Preferably, this process is controlled so that cooling is even to ensure that the pellets are durable. The product having the substantially uniform moisture content may then be stored safely or used immediately if desired.

Pellets may also be created with a process known as extrusion, whereas material is fed in an apparatus with a helixed surface attached to a rotating shaft inside a tube or cylinder. The material is then forced through a tapered die at the end of the cylinder. This force has a similar effect as rotary pellet mills as previously described. Screw extrusion allows for mixing, compounding and reacting of disparate products. Extruders can be single and double screw configurations, with double screw extruders the material is shredded during the extrusion process.

### Assay for Pellet Durability

To aid one of skill in the art to optimize pellets using different components and containing a sorghum material, such as a sweet sorghum material, pellet durability can be assayed. Generally, useful pellets are durable and do not produce large amounts of fines.

Pellet durability can be determined in with a tumbling box method following American Society of Agricultural and Biological Engineers (ASABE) standard 5269.4 (St. Joseph, Mich.; USA). This procedure generally involves placing a cooled sample of pellets in a drum with exclusions or rods extending into the drum. The drum is rotated for a set amount of time and then the material sieved with U.S. Number 6 sieve. The amount that passes over the sieve is reported as a ratio of the initial mass and this mass that pass over the sieve.

### Example

The following example is for illustrative purposes only and should not be interpreted as limitations of the claimed invention. There are a variety of alternative techniques and procedures available to those of skill in the art which would similarly permit one to successfully perform the intended invention.

Material is harvested from fields in the case of sweet sorghum material and wood lots in the case of wood product being used. Typical harvest moistures of the materials exceed 50-65% for the sorghum and 15% for the wood.

Sorghum moisture is reduced to target moisture; approximately 10% through drying in the field through generally accepted handling methods. Collection of these materials will be collected by direct harvest (e.g., “chopping” in the field) or swathing and baling.

To reduce the size of the woody material, a chipper is used, such as those manufactured by Troy-Bilt (Troy-Bilt LLC; Cleveland, Ohio, USA). This process generally involves a series of large rotating knives or drums that upon impact provide an angled force that causes small pieces to be cut or broken from the fed material. In the case of sorghum, the initial size reduction generally involves the use of a forage grinder. Forage grinders, such as those manufactured by New Holland Agriculture (New Holland, Pa., USA) are large hammer mills where pivoting weights (hammers) are on a rotating shaft that is positioned parallel to a screen. The impact of the hammers against the material against the screen results in the fed material being crushed and broken until the reduced material will pass through the screen. Screen sizes are chosen to adjust final mean particle size. The target mean particle size for the initial size reduction will be less than 1 inch in length.

After initial size reductions, a secondary size reduction step is used to homogenize the disparate materials. Attempting a large size reduction in one pass reduces throughput and increases energy demands; thus a secondary particle reduction step is advantageous, although the first particle reduction step can be continued to achieve a target length of ⅜″. This second step can use with a hammermill and screens selected to produce a mean particle size of ⅜ an inch in length.

To homogenize each material, the materials are placed in a drum mixer, ribbon mixer, or co-fed in stream to the pelleting system prior to pelleting.

The ratio of wood and sweet sorghum materials will vary based on desired outcomes, and can be adjusted by those of skill in the art. To improve the durability of principally wood pellets, small amounts of sweet sorghum material by mass is combined with wood, approximately 20 to 30% sorghum and 80 to 70% wood. Generally, this ratio is not likely to exceed more than 50% sweet sorghum material as greater amounts of sweet sorghum material can reduce pellet high heating values. If sorghum bagasse is used for the sweet sorghum material, the level of sweet sorghum material included in the pellet may be increased substantially above 50%.

In most cases, the pellets will be produced by a ring-die pellet mill. The desired pellet will be a minimum of ¼ of an inch (in diameter) with a maximum dependent upon the end user specifications, but usually will not exceed ¾″ of an inch. These ranges of pellet sizes are naturally restricting as pellets outside of these ranges (too small or too large) produce low pellet durability indices (PDI) and result in excessive fines and broken pellets.

Pellets will typically be cooled on a cooling belt, a pellet cooling manifold or a cooling chain with the objective to reduce pellet temperature and reduce friability as quickly as possible to allow handling with minimal pellet damage.

Pellet durability is determined in with a tumbling box method following American Society of Agricultural and Biological Engineers (ASABE) standard 5269.4. This procedure generally involves placing a cooled sample of pellets in a drum with exclusions or rods extending into the drum. The drum is rotated for a set amount of time and then the material sieved with U.S. Number 6 sieve. The amount that passes over the sieve is reported as a ratio of the initial mass and this mass that pass over the sieve.

If a screw extrusion process is used, the material will be co-fed into the extruder and similar pellet output specifications are met.

### REFERENCES CITED

Development of sweet sorghum as an energy crop. 1980. Batelle Laboratories Columbus Division, Columbus, Ohio.

Flick, S., K. Herman, and J. Dowell. 2011. METHOD FOR MAKING BIOMASS PELLETS. US. Publication No. 20110041390.

Gunnerman, R. 1977. FUEL PELLETS AND METHOD FOR MAKING THEM FROM ORGANIC FIBROUS MATERIALS. U.S. Pat. No. 4,015,951.

Gunnerman, R., and W. Farone. 1986. PROCESS FOR PREPARING AND USING SWEET SORGHUM IN A FUEL PRODUCT. U.S. Pat. No. 4,613,339.

Johnston, I. 1980. FUEL PELLETS. U.S. Pat. No. 4,236,897.

Levelton, B. 1966. PROCESS OF PRODUCING FUEL LOGS. U.S. Pat. No. 3,227,530.

Monk, R., F. Miller, and G. McBee. 1984. Sorghum improvement for energy production. Biomass. 6:145-153.

Myers, M., and J. Hood. 2010. PELLETS AND BRIQUETS FROM COMPACTED BIOMASS. US. Publication No. 20100300368.

von Haas, G. 2010. METHOD AND INSTALLATION FOR THE PRODUCTION OF PELLETS FROM BIOMASS IN A PELLETIZING PRESS FOR USE AS FUEL IN FURNACES. US. Publication No. 20100263267.

Zeeck, J. 2010. BIOMASS PELLETIZING PROCESS. US. Publication No. 20100281767.

1. A pellet comprising a sweet sorghum material, wherein the sweet sorghum material has a Brix value of at least 10 and functions to bind components of the pellet.

2. The pellet of claim 1, wherein the sweet sorghum material comprises at least about 1%-30% of the pellet.

3. (canceled)

4. (canceled)

5. The pellet claim 1, further comprising a biomass material.

6. The pellet of claim 5, wherein the biomass material is from an energy crop or an agricultural waste product.

7. (canceled)

8. (canceled)

9. A pellet comprising a sweet sorghum material having a Brix value of at least 10 and a woody material.

10. (canceled)

11. The pellet of claim 9, wherein the sweet sorghum material is selected from the group consisting of bagasse, stalks, leaves, stems, and grain, or a combination thereof.

12. The pellet of claim 9, wherein the woody material is in the form of wood chips, splinters, sawdust, or fine particles before being pelletized.

13. (canceled)

14. The pellet of claim 9, wherein the pellet comprises at least about 1%-50% sweet sorghum material.

15. (canceled)

16. (canceled)

17. (canceled)

18. (canceled)

19. (canceled)

20. The pellet of claim 9, wherein the woody material is processed before pelletizing, wherein the processing is one or more selected from the group consisting of: drying to a target moisture content, chopping, shredding, sawing, grinding, removing seeds, nuts or fruit, and cleaning.

21. (canceled)

22. The pellet of claim 9, wherein the sorghum material has been processed before pelletizing, and wherein the processing is one or more selected from the group consisting of: drying to a target moisture content, chopping, shredding, sawing, grinding, extracting juice, removing grains, and cleaning.

23. (canceled)

24. The pellet of claim 22, wherein the processing does not comprise extracting juice.

25. (canceled)

26. (canceled)

27. The pellet of claim 9, wherein sugars have not been removed from the sweet sorghum material before forming the pellet.

28. (canceled)

29. A method of making a pellet comprising selecting a first material to be pelletized, and co-pelletizing with a second material comprising sorghum, wherein the sorghum has a Brix value of at least 10.

30. (canceled)

31. The method of claim 29, wherein the harvest moisture of the sorghum material is greater than 50%

32. The method of claim 29, wherein the first material is wood.

33. The method of claim 29, wherein the sorghum material and the first material are subjected to a first particle reduction size step to have a mean particle size of about 1″ or less in length.

34. The method of claim 33, further comprising a second particle reduction size step, wherein the sweet sorghum material and the first material are subjected to a second particle reduction size step to have a mean particle size of about ⅜″ or less in length.

35. The method of claim 29, wherein the sorghum material and the first material are subjected to a single particle reduction size step to have a mean particle size of about ⅜″ to 1″ in length.

36. (canceled)

37. (canceled)

38. The method of claim 36, wherein the sorghum material and first material are mixed by placing in a drum mixer, a ribbon mixer, or by co-feeding in a stream into a pelletizing device.

39. The method of claim 38, wherein the mixture is formed into pellets in a ring-die pellet mill or in a screw pellet extruder.

40. The method of claim 39, wherein the pellets have a diameter of about ¼″ to 1″.

41. The method of claim 29, wherein the pellet further comprises at least a third material.

42. The method of any of claim 29, wherein the pellet further comprises a binder.
